(19) United States
(12) Patent Application Publication
(10) Pub. No.: US 2014/0342787 A1
(43) Pub. Date: Nov. 20, 2014

(54) Combine harvester

(71) Applicant: Claas Selbstfahrende Erntemaschinen GMBH, Harsewinkel (DE)

(72) Inventor: Alfons Roberg, Harsewinkel (DE)

(73) Assignee: CLAAS SELBSTFAHRENDE ERNTEMASCHINEN GMBH, Harsewinkel (DE)

(21) Appl. No.: 14/272,896

(22) Filed: May 8, 2014

(30) Foreign Application Priority Data
May 17, 2013 (DE) 10 2013 105 081.6
Jun. 19, 2013 (DE) 10 2013 106 371.3

(51) Int. Cl. A01F 12/30

(52) U.S. Cl. CPC A01F 12/30
USPC 460/83

(57) ABSTRACT

A combine harvester includes at least one device for separating a crop stream into at least two crop streams that each contains different compositions of crop components. The device delivers at least one crop stream to at least one of a number of grain pans assigned to the device. The grain pan transfers the crop stream to a cleaning mechanism. At least one roller pair extending transversely to a longitudinal axis of the combine harvester separates the crop stream. A first roller and a second roller of the roller pair have a relative speed with respect to one another.

### CROSS-REFERENCE TO A RELATED APPLICATION

The invention described and claimed hereinbelow is also described in German Priority Document DE 10 2013 105081.6, filed on May 17, 2013. The German Priority Document, the subject matter of which is incorporated herein by reference, provides the basis for a claim of priority of invention under 35 U.S.C. 119(a)-(d).

### BACKGROUND OF THE INVENTION

The present invention relates broadly to a combine harvester with a device for separating a crop stream into at least two crop streams, the two crop streams containing different compositions of crop components, where the device delivers one crop stream to one or more grain pans assigned to the device for transfer of the crop stream to a cleaning mechanism.

The quality of the process of threshing and separating grain performed by a combine harvester is dependent not only on the crop type and the crop properties, but also on the settings of the working assemblies. Grain is largely separated from non-grain components, such as straw and chaff, during the threshing process and the subsequent separation process. A first crop stream, which mainly contains grain and, to a lesser extent, straw and chaff, is delivered by the threshing and separating mechanism to a grain pain dedicated to the threshing mechanism and to a grain pan dedicated to the separating mechanism. The thusly prepared first crop stream proceeds through these grain pans to a cleaning mechanism in which non-grain components remaining in the first crop stream are separated out by wind. To this end, the cleaning mechanism comprises a fan and a plurality of sieves onto which an air stream is applied by the fan. Due to the large quantities of grain to be processed, it is not always ensured that all the grain will be threshed from the ears, and so these ears or parts of ears (some of which still comprise grain), would pass through the combine harvester and be discharged as loss together with the non-grain components. The ears or parts of ears that partially comprise grain are referred to as tailings and are usually fed to a re-threshing mechanism in order to prevent the loss of grain. A second crop stream, which substantially comprises straw and chaff, is discharged onto the field by the separating mechanism, by way of a spreading mechanism.

Such a re-threshing mechanism is known from EP 2 064 941 A1, which shows a combine harvester. The incompletely threshed crop is collected on a tailings floor and is fed by a tailings auger to a chain conveyor. The chain conveyor extends in the vertical direction on the outside of the combine harvester and conveys the tailings to a re-threshing mechanism, which is disposed in the end region of the chain conveyor. The design and mode of operation of the re-threshing mechanism correspond to that of a conventional threshing mechanism. A rotating cylinder comprising beater bars distributed around the circumference thereof is disposed in a housing. The beater bars interact with corresponding rasp bars disposed in the interior of the housing to remove the grain from the ears and to remove husks. Since a protective straw mat is missing, the re-threshing process results in a greater portion of damaged grain. The portion of damaged grain is an essential quality criterium specifically in the case of harvesting seeds, since minimizing the portion of damaged grain is of utmost importance in this case.

### SUMMARY OF THE INVENTION

The present invention overcomes the shortcomings of known arts, such as those mentioned above.

To that end, the present invention provides a combine harvester with a re-threshing mechanism for separating a crop stream by which the portion of damaged grain is minimized.

In an embodiment, the invention provides at least one roller pair extending transversely to the longitudinal axis of the combine harvester as a mechanism for separating the crop stream, wherein the first roller and the second roller thereof have a relative speed with respect to one another. Such a roller pair can be installed, as a pre-threshing mechanism, upstream of a threshing mechanism comprising at least one cylinder and one concave. Alternatively, or in addition, the pre-threshing mechanism can be used as a re-threshing mechanism in the region of the tailings auger. Likewise, the at least one roller pair can replace the conventional threshing mechanism per se, since the first roller and the second roller, due to the relative speed thereof with respect to one another, cause the grain to be separated or rasped from the ears in the sense of a threshing process.

The use of at least one roller pair instead of a conventional threshing mechanism results in a more lightweight design of a combine harvester and, primarily, the quality of the threshing process is improved by the use of at least one roller pair instead of a conventional threshing mechanism, since the grain is rasped off the ears. Rasping the grain off the ears results in less damaged grain as compared to being beaten between the cylinder and the concave of a conventional threshing mechanism.

The at least one roller pair can be disposed downstream of the at least one grain pan. The crop stream is fed to the at least one roller pair, which is installed downstream of the at least one grain pan and extends transversely to the longitudinal axis of the combine harvester. As such, the oppositely driven rollers of this roller pair have a relative speed with respect to one another. It is thereby possible to thresh the grain from the ears and disawn and de-husk the crop contained in the crop stream before transfer to the cleaning mechanism, thereby further relieving the cleaning mechanism. Moreover, the at least one roller pair is used to accelerate the relatively heavy components of the crop stream, in particular the grain, whereby these relatively heavy components are less sensitive to the air stream generated by a cleaning fan. It is the fan air stream that acts upon the straw walker step between the first grain pan and the cleaning mechanism.

A further advantage of the relative speed of the at least one roller pair is the reduction in the formation of a bridge between the rollers due to crop in the roller pocket, thereby making it possible to improve the crop intake in the intake region of the roller pair. The crop streams generated by the mechanism for separating crop are fed to the at least one roller pair, thereby permitting adjustments to be made to a mechanism for separating crop that is designed as a conventional threshing mechanism. These mechanism-enabled adjustments have a positive affect the crop quality. For example, a cylinder speed, concave separations or concave opening widths are selected that result in a threshing process associated with reduced grain damage without reducing the crop throughput of the combine harvester or overloading the cleaning mechanism. This is because the at least one roller pair prepares the crop streams in advance, i.e., these crop streams are at least partially threshed, disawned or de-husked before reaching the threshing mechanism or the cleaning mechanism.

Preferably, the rollers have a surface made of an elastic material. The design of the rollers is advantageous for preventing grain damage during the handling of the crop, i.e., during threshing.

In particular, at least one roller is configured with a rubberized surface. The result thereof is a higher coefficient of friction of the surface that processes the crop, which enhances the rasping or threshing, disawning and de-husking of the crop.

Also, the materials of the surfaces of the rollers are preferably configured to have different hardnesses. This is advantageous for reducing the portion of damaged grain. The hard grain can become partially pressed into the material of the surface of the roller having the lesser hardness, thereby enabling the process of threshing, disawning and de-husking to take place in a less damaging manner.

In an advantageous development, the surface of at least one of the rollers is formed with a profiled structure.

Furthermore, the separation between the coaxially disposed rollers is made variable. The adjustment of the axial separation of the rollers is of primary importance in the processing of different crop types and in terms of accounting for different crop conditions, such as the moisture content of the crop. The separation between the first and the second roller also can be changed such that the crop can pass between the roller pair without coming into contact therewith.

Advantageously, the first roller and the second roller have different outer diameters.

Preferably, the speed of the respective rollers is variable. This permits flexible adaptation to different crop types and crop conditions. The speed can be varied depending on the different crop types and the prevailing harvesting conditions.

Preferably, the roller having the surface with the lesser hardness is driven at the higher speed.

Moreover, the at least one roller pair is driven in a mechanical, hydraulic, or electrical manner. A mechanical drive can take the form of a belt drive, by which the roller speeds are easily adjusted.

As an alternative, the rollers are driven individually by electric motors, wherein the speed of the particular roller is easily varied by use of a frequency converter assigned to each electric motor.

Advantageously, the at least one roller pair is disposed on a plane underneath the first grain pan and above the cleaning mechanism.

In addition, a stripping element is assigned to the respective roller. This stripping element is used to at least reduce deposits on the surface of the roller, wherein deposits impair the function of the rollers.

Furthermore, the invention relates to the use of at least one roller pair as a threshing mechanism, wherein the roller pair extends transversely to the longitudinal axis of the combine harvester.

Furthermore, the use of at least one roller pair, which extends transversely to the longitudinal axis of the combine harvester is provided as a re-threshing mechanism.

### BRIEF DESCRIPTION OF THE DRAWINGS

Further features and advantages of the invention will become apparent from the description of exemplary embodiments that follows, with reference to the attached figures, wherein:

FIG. 1 presents a schematic longitudinal cross-sectional view of a combine harvester;

FIG. 2 presents an enlarged view of a subregion of the combine harvester, comprising a separating and cleaning mechanism constructed according to the invention;

FIG. 3 presents a perspective view of a roller pair constructed according to the invention;

FIG. 4 presents a top view of the roller pair presented in FIG. 3; and

FIG. 5 presents a top view of an inventive roller pair where both rollers are driven by a single drive motor.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

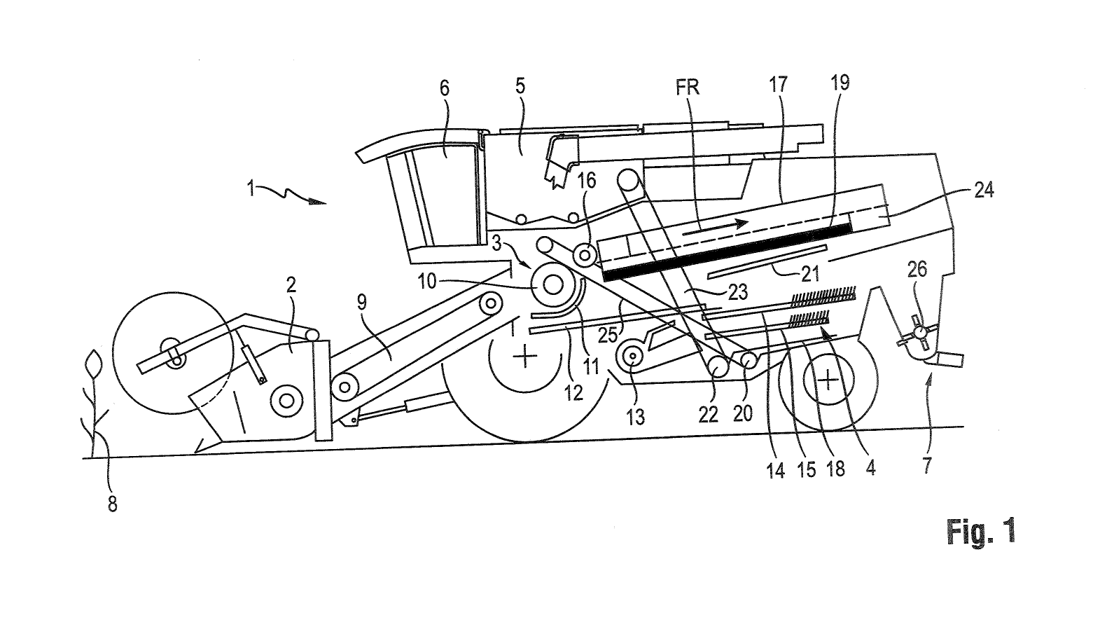

FIG. 1 shows a longitudinal sectional view of a combine harvester 1. The combine harvester 1 carries, in the front region thereof, a height-adjustable header 1. Header 1 harvests grown crop 8 across a wide width and draws this together in the lateral direction and transfers this to a feed rake 9. By way of the feed rake 9, the crop 8 reaches the threshing parts 3, in a manner known per se, wherein, in the FIG. 1 embodiment, these threshing parts comprise a cylinder 10, an impeller 16 disposed downstream thereof, and a concave 12. A crop stream, which substantially comprises a mixture of grain, short straw, and chaff, is separated from the crop 8 through openings in the concave 12 and drops to a grain pan 13. By shaking motions of the grain pan 12, which is driven in an oscillating manner, the crop thereupon is conveyed toward the rear in the direction of a cleaning mechanism 4.

The portion of the crop stream that does not pass through the concave 11 is further conveyed via the impeller 16 to a separating mechanism embodied as an axial rotor 17, which extends in the longitudinal direction of the combine harvester 1. The axial rotor 17 is enclosed in the lower region thereof by a semi-cylindrical sieve 19, by way of which a crop stream, which substantially comprises a mixture of grain and ear fragments, is separated out and reaches a return pan 21. The return pan 21 is disposed underneath the sieve 19 of the axial rotor 17.

Instead of a single axial rotor 17, two parallel axial rotors may be provided parallel next to one another. As an alternative, a tray-type shaker can be used instead of the axial rotor 17 as the separating mechanism.

Crop, substantially straw, that is ejected at the rear end 24 of the axial rotor 17 reaches a spreader 7 at the rear of the combine harvester 1. There, this straw crop is chopped up by a chopper 26 and, finally, is deposited onto the field.

On the return pan 21, which is moved in a shaking manner, the crop delivered by the sieve 19 is conveyed forward in the direction of the threshing parts 3 and is transferred to the cleaning mechanism 4. There, the crop stream from the return pan 21 is combined with the crop stream that passed through the concave 11, which is transferred from the grain pan 12 to the cleaning mechanism 4.

The cleaning mechanism 4 comprises an upper sieve 14, a lower sieve 15 and a cleaning fan 13, which generates an air stream that passes through and over the sieves 14, 15. The grain contained in the crop flows arriving from the grain pan 12 or the return pan 21 passes the upper sieve 14 and the lower sieve 16 in succession and reaches, by way of a pan 18 located underneath, an auger conveyance device 22 and a grain elevator 23. The grain elevator conveys this grain into a grain tank 5 disposed at the back of the driver's cab 6.

Portions of the crop stream that are more lightweight than the grain are captured by the air stream generated by the cleaning fan 13 as these portions drop from the grain pan 12 onto the upper sieve 14, from the upper sieve 14 onto the lower sieve 15, or from the lower sieve 15 onto the pan 18. These lightweight portions are carried along and reach the spreader 7, by which these portions are ejected. Heavy, coarser portions of the crop stream, such as non-threshed ear tips, continue by way of tailings at the rear end of the sieves 14, 15 to a trough. The trough extends transversely underneath the sieves 14, 15. An auger 20, which rotates in the trough, moves the material sideways to a tailings elevator 25, which conveys this material back to the threshing parts 3.

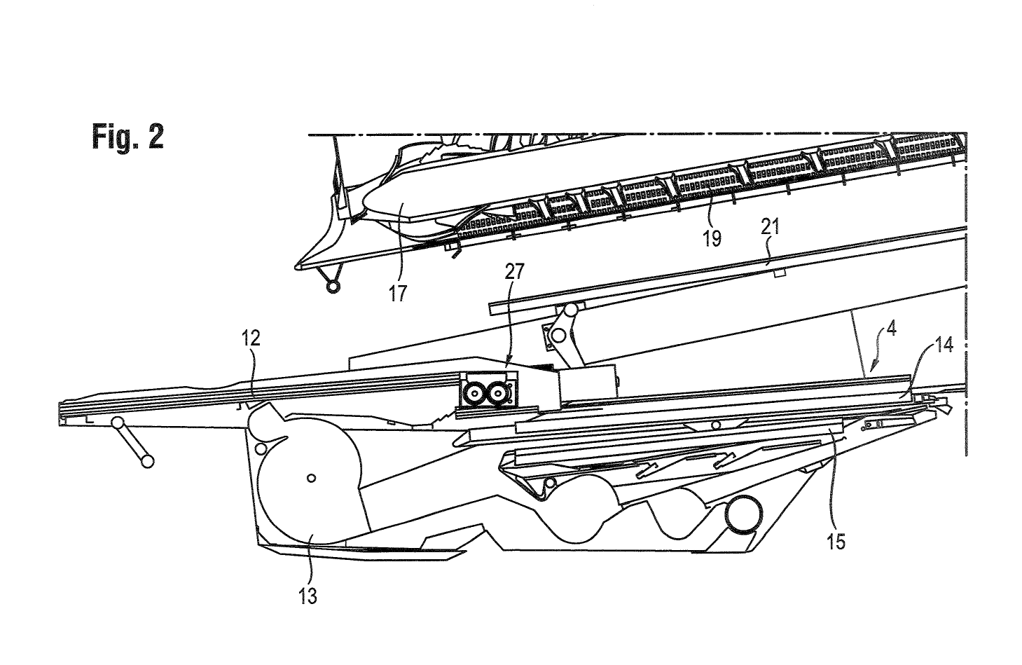

FIG. 2 shows an enlarged view of a subregion of the combine harvester, comprising the separating and cleaning mechanism. The representation shows the arrangement of the grain pan 12 and return pan 21 relative to one another, to which at least one roller pair 27 is assigned. The at least one roller pair 27 is disposed downstream of the grain pan 12, and therefore crop delivered thereby is fed to the roller pair 27 for retreatment. Crop delivered by the return pan 21 first reaches the grain pan 12 or is delivered directly to the roller pair 27. The roller pair 27 delivers the retreated crop to the cleaning mechanism 4, to which this crop is fed, in a free fall, across a short distance. While crossing this distance, the retreated crop is subjected to an air stream generated by the cleaning fan 13. The air stream removes the non-grain components, while the heavier grain components reach the upper sieve 14 of the cleaning mechanism 4. The additional acceleration of the crop by the roller pair 27 makes it possible to increase the speed of the cleaning fan 13, thereby making it possible to increase the output of the cleaning mechanism 4. The portion of crop that must be fed, as tailings, back to the threshing parts 3 is thereby reduced.

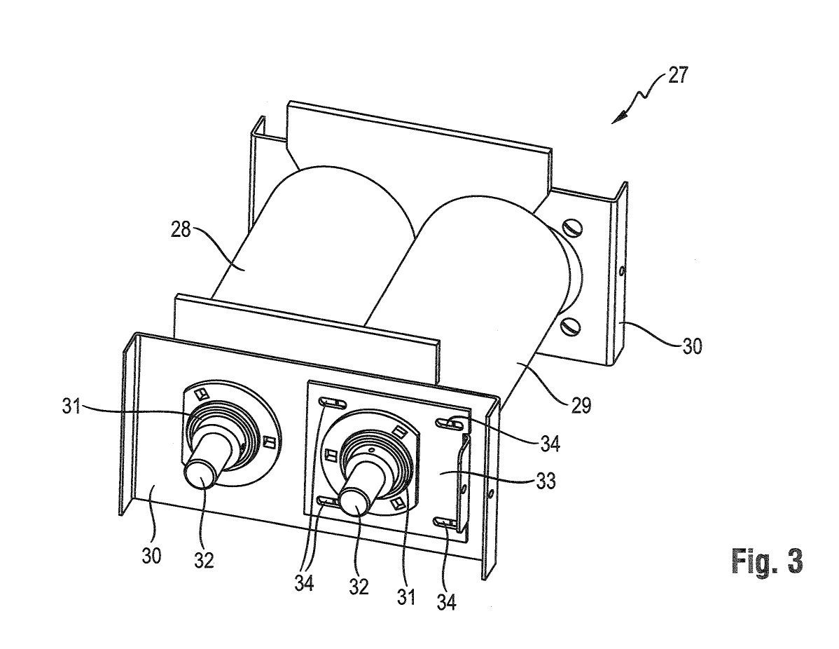

FIG. 3 shows a perspective view of a roller pair 27 comprising a first roller 28 and a second roller 29. The roller pair 27 is disposed between two frame elements 30, which are designed as mirror images of one another, and therefore an illustration of the opposite side is omitted. Bearing points 31, such as bearing bushes, for example, are disposed in the frame elements 30 such that the first roller 28 and the second roller 29 are rotatably supported. The first roller 28 and the second roller 29 each have a rotational axis 32, both of which extend beyond the corresponding bearing point 31 on at least one side. The rotational axes 32 are therefore connected to a drive. As is also evident from the illustration in FIG. 3, the second roller 28 is displaceable in the longitudinal direction relative to the frame element 30.

To this end, a plate 33 is disposed on the frame element 30. The plate has slots 34 that enable the plate 33 to be displaced and fixed in position relative to the frame element 30. The plate 33 is manually displaced, thereby permitting the separation between the rotational axes 32 of the roller pair 27 relative to one another to be changed in order to adapt to various types of crop to be processed. The displacement and affixation can be performed manually, as described above. It also is feasible, however, to permit the separation between the rotational axes to be adjusted depending on the type of crop by an automatic displacement of one of the rotational axes relative to the other rotational axis of the roller pair.

The first roller 28 and the second roller 29 have a surface formed of different elastic materials, wherein the particular materials have different hardnesses. In particular, one of the two rollers 28, 29 has a rubberized surface, and therefore the crop is partially pressed into the surface resulting in non-damaging processing.

The first and the second roller 28, 29 are driven mechanically by a belt drive or electrically using an electric motor regulated by a frequency converter. Depending on the type of drive, a fixed transmission ratio is specified for the drive speeds of the two rollers 28, 29, or the first roller 28 and the second roller 29 are driven independently of one another. The relative speed between the first roller 28 and the second roller 29 induces a frictional effect. With the friction effect, the crop delivered by the grain pan 12 to the roller pair 27 is threshed, disawned and de-husked by the rasping that occurs.

A further advantage provided by the invention is that the crop intake is improved by the rollers, since the formation of a bridge in the roller pocket is prevented. The awns and husks that are separated from the grains in the crop due to the friction between the first roller 28 and the second roller 29 are captured by the air stream (which is delivered by the cleaning fan 13) and are conveyed through the sieves 14, 15 and in the direction of the chopper 26. In order to compensate for the influence of the air stream delivered by the cleaning fan 13, which substantially impacts the crop transversely to the dropping direction during the free fall of this crop after emerging from the roller pair 27, the crop is additionally accelerated by the roller pair 27. By this additional acceleration, the relatively heavier grain components are deflected to a lesser extent by the air stream delivered by the cleaning fan 13, while the much more lightweight awns and husks are carried away, at least in part, by this air stream.

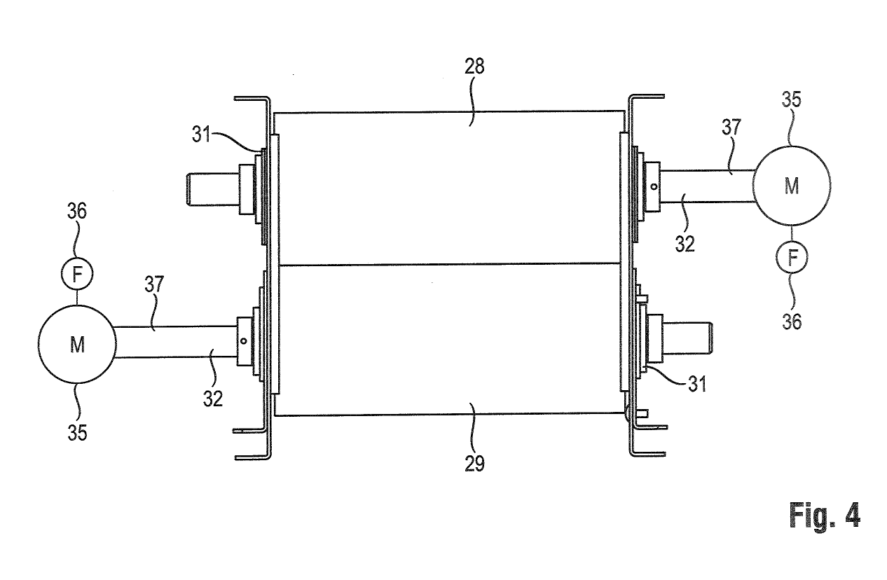

FIG. 4 shows a top view of the roller pair 27 according to FIG. 3, wherein each of the rollers 28, 29 is driven by a single motor, preferably a three-phase A.C. electric motor 35. The electric motors 35 are drivably connected, via a drive shaft 37, to the rotational axis 32 of the respective roller 28, 29. The electric motors 35 are regulated by frequency converters 36 in order to provide various drive speeds. The separation between the electric motors 35 is changed in accordance with the separation between the rotational axes 32 relative to one another.

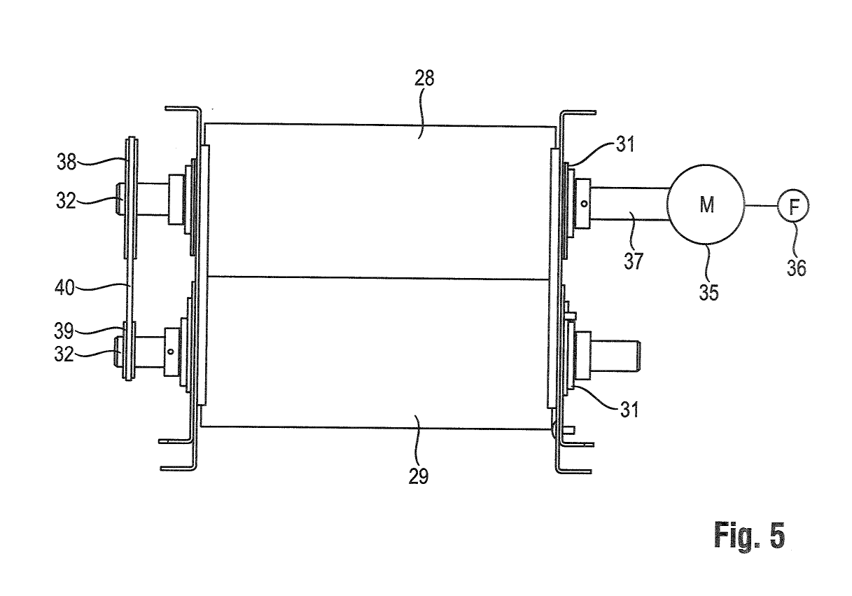

In the FIG. 5 embodiment, the first roller 28 is driven by the electric motor 35, which is drivably connected to the rotational axis 32, wherein this electric motor 35 is regulated by the frequency converter 36. On the side opposite the first roller 28, a first pulley 38 is flange-mounted on the rotational axis 32, wherein this pulley is operatively connected, via a belt 40, to a second pulley 39. Second pulley 39 is disposed on the rotational axis 32 of the second roller 29. A speed ratio between the first roller 28 and the second roller 29 is established by the different sizes of the first and the second pulleys 38, 39, while the drive speed delivered by the electric motor 35 is variable in order to be adaptable to different crop types and various throughput quantities. In the case of the belt-driven roller pair 27 (FIG. 3), the belt 40 is held under tension by a guide roller in order to maintain the belt tension in the event the separation between the rotational axes 32 of the first roller 28 and the second roller 29 is changed, wherein the position of the guide roller is adjusted accordingly.

A further option is to additionally provide at least one more above-described roller pair 27 in the region of the tailings elevator 25. By this additional roller pair 27, the crop that is delivered by the cleaning mechanism 4 as tailings is reprocessed before this crop is transferred from the tailings elevator 25 to the threshing parts 3 or by a suitable conveyor mechanism directly to the cleaning mechanism 4.

### LIST OF REFERENCE CHARACTERS

1 combine harvester
2 header
3 threshing parts
4 cleaning mechanism
5 grain tank
6 driver's cab
7 spreader
8 crop
9 feed rake
10 cylinder
11 concave
12 grain pan
13 cleaning fan
14 upper sieve
15 lower sieve
16 impeller
17 axial rotor
18 ground
19 sieve
20 auger
21 return pan
22 auger conveyance device
23 grain elevator
24 rear end
25 tailings elevator
26 chopper
27 roller pair
28 first roller
29 second roller
30 frame element
31 bearing point
32 rotational axis
33 plate
34 slot
35 electric motor
36 frequency converter
37 drive shaft
38 first pulley
39 second pulley
40 belt

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A combine harvester, comprising:
at least one device for separating a crop stream into at least two crop streams that each contain different compositions of crop components and, for delivering at least one of the crop streams to at least one grain pan assigned to the at least one device for transferring the crop stream to a cleaning mechanism; and
at least one roller pair extending transversely to a longitudinal axis of the combine harvester separating the crop stream, wherein a first roller of the roller pair operates at a relative speed with respect to a second roller of the roller pair.

2. The combine harvester according to claim 1, wherein the at least one roller pair is disposed downstream of the at least one grain pan).

3. The combine harvester according to claim 1, wherein the first roller and the second roller have a surface formed of an elastic material.

4. The combine harvester according to claim 3, wherein at least one roller of the roller pair has a rubberized surface.

5. The combine harvester according to claim 1, wherein materials from which surfaces of the first roller and the second roller are formed have different hardnesses.

6. The combine harvester according to claim 1, wherein a surface of at least one of the first and second rollers has a profiled structure.

7. The combine harvester according to claim 1, wherein the first roller and the second roller are disposed coaxially relative to one another and wherein a separation between the first roller and the second roller is variable.

8. The combine harvester according to claim 1, wherein the first roller and the second roller have different outer diameters.

9. The combine harvester according to claim 1, wherein a rotational speed of the first roller and the second roller (29) is variable.

10. The combine harvester according to claim 1, wherein the at least one roller pair is driven in any of a mechanical, a hydraulic and an electrical manner.

11. The combine harvester according to claim 1, wherein the at least one roller pair is disposed on a plane underneath the first grain pan and above the cleaning mechanism.

12. The combine harvester according to claim 1, wherein the first roller and the second roller are each assigned a stripping element.

13. The combine harvester according to claim 1, wherein the roller pair extends transversely to the longitudinal axis of the combine harvester to operate as a threshing mechanism.

13. The combine harvester according to claim 1, wherein the roller pair extends transversely to the longitudinal axis of the combine harvester to operate as a re-threshing mechanism.
